(19) United States
(12) Patent Application Publication
(10) Pub. No.: US 2012/0041850 A1
(43) Pub. Date: Feb. 16, 2012

(54) INCENTIVIZING CONTENT-RECEIVERS IN SOCIAL NETWORKS

(75) Inventor: Rodric Rabbah, Yonkers, NY (US)

(73) Assignee: International Business Machines, Inc., Armonk, NY (US)

(21) Appl. No.: 12/853,981

(22) Filed: Aug. 10, 2010

(51) Int. Cl. G06Q 30/00; G06Q 10/00

(52) U.S. Cl. 705/30; 705/1.1

(57) ABSTRACT

An embodiment of the invention provides a method including receiving a request to publish first content on a system from a user. A fee is imposed to the user to publish the first content. The first content is published on the system. In at least one embodiment, an amount of net credits of the user is published on a profile of the user. A credit is provided to the user for each instance the user receives second content from the system, the credit being non-redeemable for cash. The credit is provided to the user at pre-determined time intervals and/or when pre-determined milestones reached. In at least one embodiment, the fee is credited to the user if the first content is a comment to existing content.

### BACKGROUND

The present invention is in the field of methods, systems, and computer program products for incentivizing content-receivers in social networks.

The Internet provides access to numerous social and business networking applications (e.g., FACEBOOK®, LINKEDIN®). Modern technological advances have made the Internet more accessible at faster connection speeds. As a result, such web applications have become an increasingly popular means for people to communicate with their friends, family, and colleagues. For example, members of social networking sites are able to stay in touch with their friends and family by sharing and receiving photographs, videos, electronic messages, and status updates.

Social networking and information exchange on the Internet is largely free today for end-users. For example, someone using the TWITTER® website may publish updates at no additional costs, and someone interested in receiving such updates may subscribe to that user's stream of updates (a.k.a., following someone) at no additional cost.

### SUMMARY OF THE INVENTION

An embodiment of the invention includes methods, systems, and computer program products for incentivizing content-receivers in social networks. More specifically, a request to publish first content on a system is received from a user, wherein the user is an account on the system operated by at least one end-user. A fee is imposed to the user to publish the first content. In one embodiment of the invention, the fee is imposed each time a request to publish first content is received from the user. In another embodiment, the fee is imposed each time the first content is accessed by another user of the system. In yet another embodiment, the fee is only imposed if the user requests to publish new content.

The first content is published on the system. In at least one embodiment, an amount of net credits of the user is published on a profile of the user. A credit is provided to the user for each instance the user receives second content from the system, the credit being non-redeemable for cash. The credit is provided to the user at pre-determined time intervals and/or when pre-determined milestones reached. In at least one embodiment, the fee is credited to the user if the first content is a comment to existing content.

Another embodiment of the invention includes a system for incentivizing content-receivers in social networks, wherein the system includes an interface for receiving a request to publish first content on a system from a user. A fee accounting module imposes a fee to the user to publish the first content, wherein the fee accounting module imposes the fee each time a request to publish first content is received from the user. In another embodiment, the fee accounting module imposes the fee each time the first content is accessed by another user of the system. In yet another embodiment, the fee accounting module only imposes the fee if the user requests to publish new content.

A processor is provided for publishing the first content from the user on the system. In at least one embodiment, the processor publishes an amount of net credits of the user on a profile of the user. The system further includes a credit accounting module for providing a credit to the user for each instance the user receives second content from the system, the credit being non-redeemable for cash. The credit accounting module provides the credit to the user at pre-determined time intervals and/or when pre-determined milestones reached. In at least one embodiment, the credit accounting module credits the fee to the user if the first content is a comment to existing content.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a method for incentivizing content-receivers in social networks according to an embodiment of the invention;

FIG. 2 illustrates a device for incentivizing content-receivers in social networks according to an embodiment of the invention; and

FIG. 3 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention includes a social networking stimulus initiative wherein someone using a social networking website who's interested in publishing content (e.g., a TWITTER® update) pays a credit (e.g., $0.01) to publish the content to every person who's interested in receiving it. For users with “tight” social connections, they will exchange information at an equal rate so that the end-sum for individual users in tight-relations is zero, i.e., they pay as much as they receive.

For users of a social networking website having “weak” relationships, meaning for example a pair of users where the first user is an active publisher and the second user is simply a subscriber, there is a net gain to be had by the second user and a cost for the first user. Advertisers and spammers (unsolicited mass advertisers) fall into the category of the first user, i.e., the amount of content that they publish is much larger than the amount of content that they receive. Thus, the social networking stimulus initiative is attractive for legitimate users of the social networking website and puts a burden on spammers and advertisers.

In at least one embodiment of the invention, in order to avoid the problem of making legitimate content providers pay to publish content, users can opt to give back the credit at their choosing. For example this is the default mode in a deployed system, wherein users can turn on an option to start collecting credits. Thus, users are able to sell their strong relationships to advertisers. In another embodiment, a presiding body (e.g., the website administrator for XYZBLOG.COM) determines whether a publisher can provide content at no additional costs.

An embodiment of the invention includes a third party service provider that tracks the exchange of the credits between content publishers and content subscribers. In one embodiment, credits are collected and distributed at certain time periods (e.g., end of a month) so as to avoid swings in credit exchanges. In another embodiment, the third party service provider retains a portion of collected credits for their own profit.

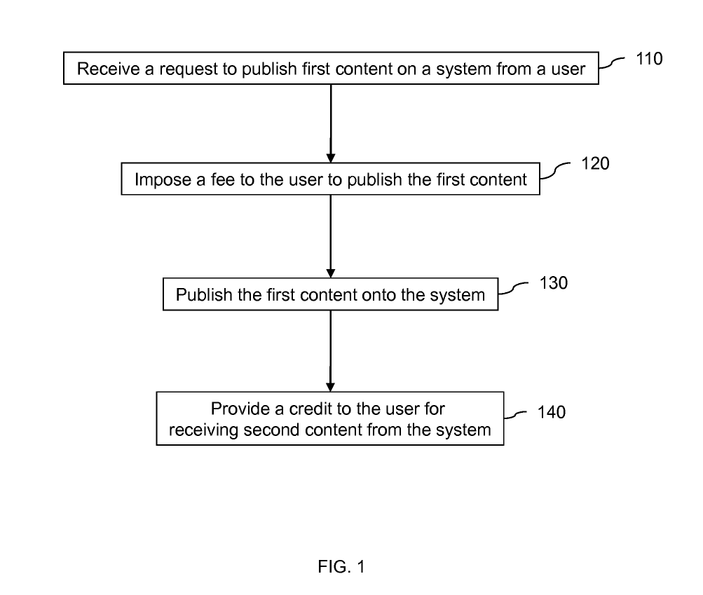

FIG. 1 illustrates a method for incentivizing content-receivers in social networks according to an embodiment of the invention. A request to publish (e.g., post) first content on a system is received from a user 110. In at least one embodiment, the user is an account on the system, e.g., John Doe's LINKEDIN® account or Corporation XYZ's MYSPACE® account. In another embodiment, the user are the human end-user(s) that are operating the account, e.g., John Doe or the employees of Corporation XYZ.

In at least one embodiment, the system is a website, such as a social or professional networking website (e.g., LINKEDIN®), a personal dating website (e.g., MATCH.COM®), a blog, an e-mail list serve, a wiki, and/or a chat room. In another embodiment, the system is a network, such as a local-area network (LAN) or a wide-area network (WAN). The first content includes images, audio files, video files, hyperlinks, and/or text, such as status updates, wall posts, comments, and/or electronic messages. For example, John submits a request via his FACEBOOK® account to comment on a friend's status by typing text into the text box beneath the friend's status display and clicking ENTER.

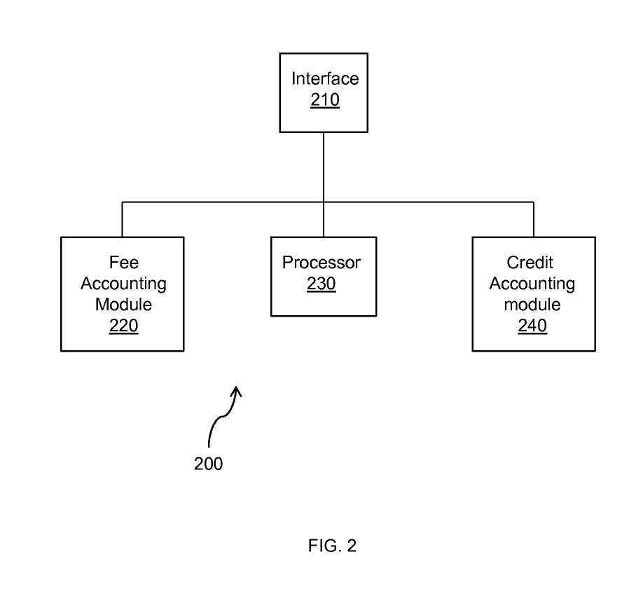

A fee is imposed to the user to publish the first content 120. FIG. 2 illustrates a device or system 200 for incentivizing content-receivers in social networks according to an embodiment of the invention, wherein a fee accounting module 220 is connected to an interface 210. The interface 210 receives the request to publish the first content on the system; and, the fee accounting module 220 imposes the user a fee.

In at least one embodiment of the invention, the fee is imposed each time a request to publish first content is received from the user. For example, if a $0.01 fee is imposed on the user for every request to publish first content, and the user changes his status, submits 3 wall posts, comments on 2 of his friend's photos, and posts 20 photos, then a $0.26 fee is imposed on the user. In one embodiment, the amount of the fee varies depending on the type of first content. For example, a $0.01 is imposed on wall posts and a $0.05 is imposed on a request to post a video.

In at least one embodiment, the term “imposed” is defined as accruing, assessing or levying (e.g., a fee to the user for a request to publish); and, the term “charged” is defined as demanding or billing the fee to the user. For example, the fee is imposed or is accrued when the request to publish is received; and, the fee is charged when the fee is billed to the user (e.g., the 15th of every month).

In another embodiment of the invention, the fee is imposed each time the first content is accessed by another user of the system. For example, John comments on a photo on Jane's profile pages, but the fee is not imposed until the photo comment is accessed by Jane. As used herein, the term “accessed” is defined as viewed (e.g., a photo comment is displayed in another user's account), clicked on (e.g., another user clicks on a thumbnail photograph published on her account), or commented on (e.g., a user comments on a comment made by another user). For example, if a $0.01 fee is imposed on the user each time the first content is accessed, the user posts 4 wall posts, 50 photos, and comments on 3 of his friend's status updates, but only 2 of the wall posts, 5 of the photos, and 1 of the comments are accessed, then a $0.09 fee is imposed on the user.

In one embodiment of the invention, the fee is charged to the user at pre-determined time intervals (e.g., every Monday; daily at 12:00 a.m.; the 15th of every month). In another embodiment, the fee is charged to the user when pre-determined milestones are reached. For example, the user has a LINKEDIN® account that is charged after 50 messages are sent or received by the user. In another example, the user has a MYSPACE® account that is charged after 500 requests to publish first content are received from the user.

The interface 210 is also connected to a processor 230, which publishes the first content from the user onto the system 130. For example, the processor 230 publishes a wall post from the user on the profile page of the user's friend. In another embodiment, the processor 230 publishes a photo comment from the user on the profile page of the user's friend. The device 200 further includes a credit accounting module 240 for providing a credit to the user for receiving (e.g., accessing, viewing, and/or clicking on) second content from the system 140. The second content includes images, audio files, video files, hyperlinks, and/or text, such as status updates, wall posts, comments, and/or electronic messages. For example, if a $0.05 credit is provided to the user for viewing second content, and the user receives 10 status updates, 5 photos, and 3 wall posts from other users of the system, then a $0.90 credit is provided to the user. In one embodiment, the amount of the credit varies depending on the type of second content received. For example, the user is provided a $0.01 credit for receiving messages and a $0.10 credit for receiving status updates from the system.

In one embodiment of the invention, the amount of net credits (credits provided minus fees imposed) is published on the profile pages associated with the user. For example, if a user is acting mostly as a subscriber and is not actively publishing content, other users may choose not to publish further content on that user's profile. Thus, a spammer that establishes a profile desires that users publish content onto their profile, so that the spammer can accumulate credits. A user who does not want to publish content on a spammer's profile may be able to identify a spammer if the spammer's profile displays a large deficit in credits (i.e., publishing/sending a large amount of content, but receiving a small amount of content published to their profile). In another embodiment, profile pages associated with the user include a published label indicating that the user is a “Publisher” (has credits below a predetermined minimum threshold), a “Subscriber” (has credits above a predetermined maximum threshold), or “Neutral” (has credits between the predetermined minimum threshold and predetermined maximum threshold).

A request to publish content in response to existing content (e.g., another user's wall post, status update, and/or photograph) is less likely to be an unsolicited advertisement than a request to publish new content. Thus, at least one embodiment of the invention only imposes a fee to the user if the user requests to publish new content, e.g., a new status update, a new wall post, a new photograph—not a comment to existing content. For example, the user is not imposed a fee if the user is commenting on an existing status update of another user. In another embodiment, a fee is imposed on the user for commenting on existing content, however, the fee is credited back to the user by the credit accounting module 240. For example, the user is imposed a $0.10 fee for commenting on an existing photo of another user, but the fee is never charged because the user is provided a $0.10 credit at the end of a monthly billing cycle.

In at least one embodiment of the invention, the credit is provided to the user at pre-determined time intervals, e.g., the 1st of every month. In another embodiment, the credit is provided to the user when pre-determined milestones are reached. For example, the credit is provided to the user after 100 items (e.g., status updates, photos, and/or wall posts) are displayed on his news feed. In at least one embodiment, the credit is not redeemable for cash value. In other words, the credit cannot be redeemed for cash and is only usable to off-set the fees.

In another embodiment of the invention, fees are imposed and credits are provided to a user's account for content published and received, respectively, across different systems (e.g., across different social networking websites). Thus, for example, a user's FACEBOOK® account is provided a credit for content received from her MYSPACE® and LINKEDIN® accounts. If the user has multiple linked accounts, the user is given the option to select which account(s) will receive credits and which account(s) will be imposed fees.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

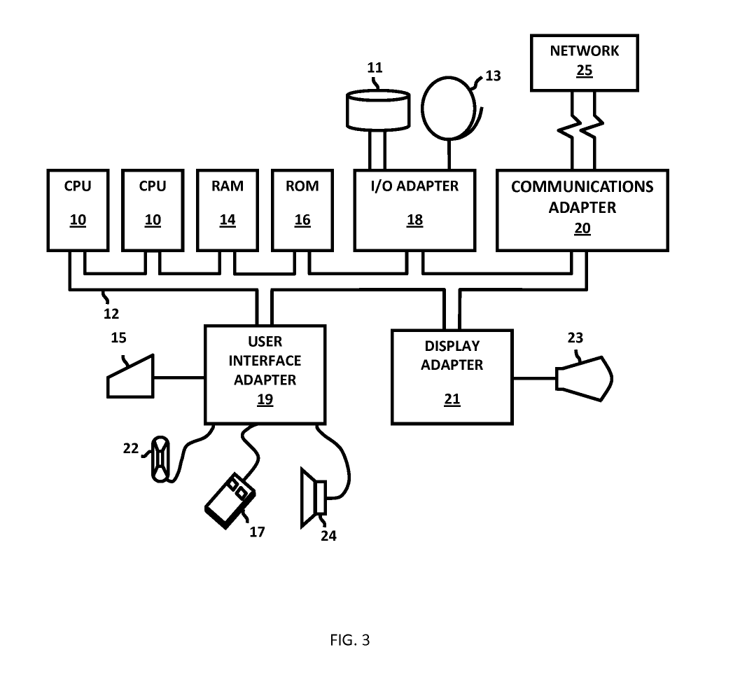

Referring now to FIG. 3, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 19. The I/O adapter 19 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, including:
receiving a request to publish first content on a system from a user;
imposing a fee to the user to publish the first content;
publishing the first content from the user on the system; and
providing a credit to the user for each instance the user receives second content from the system, the credit being non-redeemable for cash.

2. The method according to claim 1, wherein the fee is imposed each time a request to publish first content is received from the user.

3. The method according to claim 1, wherein the fee is imposed each time the first content is accessed by another user of the system.

4. The method according to claim 1, wherein the credit is provided to the user at least one of:
at pre-determined time intervals, and
when pre-determined milestones reached.

5. The method according to claim 1, wherein said imposing of the fee is only performed if the user requests to publish new content.

6. The method according to claim 1, further including crediting the fee to the user if the first content is a comment to existing content.

7. The method according to claim 1, further including publishing an amount of net credits of the user on a profile of the user.

8. The method according to claim 1, wherein the user is an account on the system operated by at least one end-user.

9. A method, including:
receiving a request to publish first content on a system from a user;
imposing a fee to the user to publish the first content;
publishing the first content from the user on the system; and
providing a credit to the user for receiving second content from the system.

10. The method according to claim 9, wherein the fee is imposed each time a request to publish first content is received from the user.

11. The method according to claim 9, wherein the fee is imposed each time the first content is accessed by another user of the system.

12. The method according to claim 9, wherein the credit is provided for each instance the user receives second content from the system.

13. The method according to claim 9, wherein the credit is provided to the user at least one of:
at pre-determined time intervals, and
when pre-determined milestones reached.

14. The method according to claim 9, wherein the credit is non-redeemable for cash value.

15. The method according to claim 9, wherein said imposing of the fee is only performed if the user requests to publish new content.

16. The method according to claim 9, further including crediting the fee to the user if the first content is a comment to existing content.

17. The method according to claim 9, further including publishing an amount of net credits of the user on a profile of the user.

18. A device, including:
an interface for receiving a request to publish first content on a system from a user;
a fee accounting module for imposing a fee to the user to publish the first content;
a processor for publishing the first content from the user on the system; and
a credit accounting module providing a credit to the user for each instance the user receives second content from the system, the credit being non-redeemable for cash.

19. The device according to claim 18, wherein said fee accounting module imposes the fee each time a request to publish first content is received from the user.

20. The device according to claim 18, wherein said fee accounting module imposes the fee each time the first content is accessed by another user of the system.

21. The device according to claim 18, wherein said credit accounting module provides the credit to the user at least one of:
at pre-determined time intervals, and
when pre-determined milestones reached.

22. The device according to claim 18, wherein said fee accounting module only imposes the fee if the user requests to publish new content.

23. The device according to claim 18, wherein said credit accounting module credits the fee to the user if the first content is a comment to existing content.

24. The device according to claim 18, wherein said processor publishes an amount of net credits of the user on a profile of the user.

25. A computer program product, including:
a computer readable storage medium;
first program instructions to receive a request to publish first content on a system from a user;
second program instructions to impose a fee to the user to publish the first content;
third program instructions to publish the first content from the user on the system; and
fourth program instructions to provide a credit to the user for each instance the user receives second content from the system, the credit being non-redeemable for cash,
said first program instructions, said second program instructions, said third program instructions, and said fourth program instructions are stored on said computer readable storage medium.
